(19) United States
(12) Patent Application Publication
(10) Pub. No.: US 2006/0170122 A1
(43) Pub. Date: Aug. 3, 2006

(54) Method for improving the quality of e.g. an optic product, such as a mobile phone lens

(76) Inventor: Jari Ruuttu, Billnas (FI)

Correspondence Address: YOUNG & THOMPSON, 745 SOUTH 23RD STREET, 2ND FLOOR, ARLINGTON, VA, 22202, US

(21) Appl. No.: 10/503,622

(22) PCT Filed: Feb. 6, 2003
(86) PCT No.: PCT/FI03/00093

§ 371 Date: May 10, 2005

(30) Foreign Application Priority Data
Feb. 6, 2002 (FI) 20020239

(51) Int. Cl. B29D 11/00

(52) U.S. Cl. 264/1.32; 264/1.33

(57) ABSTRACT

A method for manufacturing a work piece allows the work piece to be removed in the manufacturing step, e.g. an injection-moulding step, to be transferred between various further processing steps, to be shifted and treated quite automatically in these without having to touch the desired end product at any stage regardless of the work process, unless the work process, as tampon printing, for instance, requires it to be touched, and regardless of the physical dimensions or shapes of the product. The method uses two work planes, which are disposed substantially in the same plane and between which the product/products are formed using the injection-moulding method, for instance.

The invention relates to a method for improving the quality of especially optical products, such as mobile phone lenses, display covers, protective glasses, spectacles, sunglasses, watch cover glasses, aircraft windows, especially in cases where additional working processes are required besides the actual injection-moulding process in order to achieve the end product.

It should be noted that, although this application focuses on optical products, the invention obviously relates also to other product groups than the optical product group mentioned here, such as mobile phone covers, car parts, parts made of rubber, parts made of other than transparent plastic, generally speaking, all parts subjected to some kind of further processing; here the mobile phone lens is given as an example, because it is by far the most difficult product.

The invention also relates to a product manufactured by other methods meeting the requirements of this invention. Such methods are:

A. A plastic injection-moulding process

B. A plastic cold-working process, e.g. deep-drawing and punching processes

C. A plastic hot-working process, e.g. deep-drawing and punching processes

D. A metal pressure-casting process, e.g. silumin etc.

E. A metal working process, cf. items B and C

F. A plastic dead-mould casting process

The method is advantageously used especially in product groups, which require total cleanness and in which the products are subjected to further processing, e.g. coating processes, after the actual work piece has been manufactured, whereby the end product cannot or must not be touched, because it would impair the quality of the end product, for instance, by deteriorating the optical properties, making coating operations more difficult, etc.

An example of this is an optical work piece such as a lens, which undergoes several processes after the actual work piece has been manufactured. The work process may be e.g. an injection-moulding process. The drawback of known previously used methods which are eliminated by the new invention consists in the fact that the work pieces will necessarily be touched when the product is withdrawn from the mould in the injection moulding process and that the product will be touched in the course of the different work steps.

Especially in optical products, the lens shall be quite flawless from the very beginning of the injection-moulding step, and naturally also during and after the further processing steps, however, if the product is not flawless in the injection-moulding step, it will not be so after the further processing step either. In other words, further processing steps require an absolutely flawless work piece.

Known methods and Problems

The first problem is caused by the fact that one has to touch the work piece itself, e.g. the surface of an optical end-product.

This is precisely how the most commonly used manufacturing method operates; when the injection-moulding process is completed and the mould is opened, a robot or a manipulator equipped with suction pads passes between the mould segments to grip the work piece with the suction pads, at the optical surface itself, there being no other free surfaces, in the case of lenses, for instance, in order to remove the product, after which the mould segments can be closed.

As stated above, optical surfaces must not be touched at any stage of the work process, because this would deteriorate or destroy the product completely.

During mould removal the surface of the product is touched, because no other rapid and reliable method has been suggested.

Touching the work piece after the injection-moulding process results in the following problems:

The temperature of the work piece +60-120° C., depending on the plastic quality and the cooling temperature in the mould and on the cooling time.

Additionally, it should be considered that an optical product, e.g. a mobile phone lens (window, cover) is extremely thin, 1.0 to 2.5 mm, and it may have a shape other than a planar, straight surface.

Such a work piece is naturally extremely susceptible both with regard to the surface and to the shape, and for optimal results, the product should be allowed to cool very evenly and controllably.

When the piece is touched with suction pads, for instance, there will be at least two very detrimental consequences for the product and for further processing.

First, material will come off the surface of the suction pad and adhere to the work piece, the material being subsequently impossible to remove without damaging the surface, thus causing flaws in further processing.

Second, touching the warm surface causes deformation of the surface, affecting the optical properties, deformations as such deteriorating optical properties and being further accentuated in various coatings.

Third, a warm work piece is very susceptible to deformation, in other words, there will be weakening stress or generally stresses released in the further processing or entailing a deformation of the surface or the work piece, which destroys the optical properties before further processing is even started.

Besides optical deformation, they cause e.g. aurea borealis circles, and such a work piece is useless.

The fact that further processing methods have not been taken into account is natural, because further processing is new and all of these processes are not even known yet, and have thus not been allowed for in the design of the work process and the work piece. In fact, the trend has been opposite to developments that would have been beneficial for further processing of work pieces. The prevailing trend has consistently been to provide a work piece with finished physical dimensions directly after the manufactured process, e.g. an injection-moulding process.

As stated above, a trend aiming at achieving a work piece having completed physical dimensions during its manufacturing process, e.g. a plastic injection-moulding process, is perfectly natural. Since there has been no need for further processing methods, avoiding any operations on the physical work piece after the manufacture of the actual work piece has been entirely in focus.

This has largely related to the adoption of hot-channel techniques, where no typical casting block is formed during the injection-moulding process, for instance.

This trend makes sense, since waste is avoided and the work piece is immediately finished, in other words, it can be delivered to the customer.

Consequently, a finished work piece has been achieved efficiently and rapidly, however, at the expense of making further processing more difficult.

New products, such as a mobile phone equipped with a colour display, poses quite different requirements than say, one year ago. The resolution of a colour display is so high that any defects are immediately revealed, and what is more, the lens shall have new functions, such as a non-reflective surface and a scratch free surface. Nowadays, it should be possible to add an external part, such as a tape or a seal, and to print a single-colour or multi-colour logo, and also, it should be possible to remove part of the protective coating (UV varnish) from the areas intended for ultrasound welding.

An excellent method for manufacturing a work piece has thus been consciously developed, yet on the condition that there is no further processing. However, as stated above, further processing is absolutely necessary in order to achieve a product, i.e. work piece meeting new requirements.

So far, we have discussed problems relating to the first work process of a finished product, such as injection moulding and removal of the work piece from the mould for further processing.

The following problems relate specifically to further processing.

The major individual problem is the prohibition to touch the surface of the work piece, yet currently used methods involve touching the surface, except for a number of processes that provide somewhat better facilities for further processing, yet do not resolve the problem in a satisfactory manner.

The new invention is compared below to known methods, describing solutions of various types for manufacturing a work piece so as to allow further processing in different work processes.

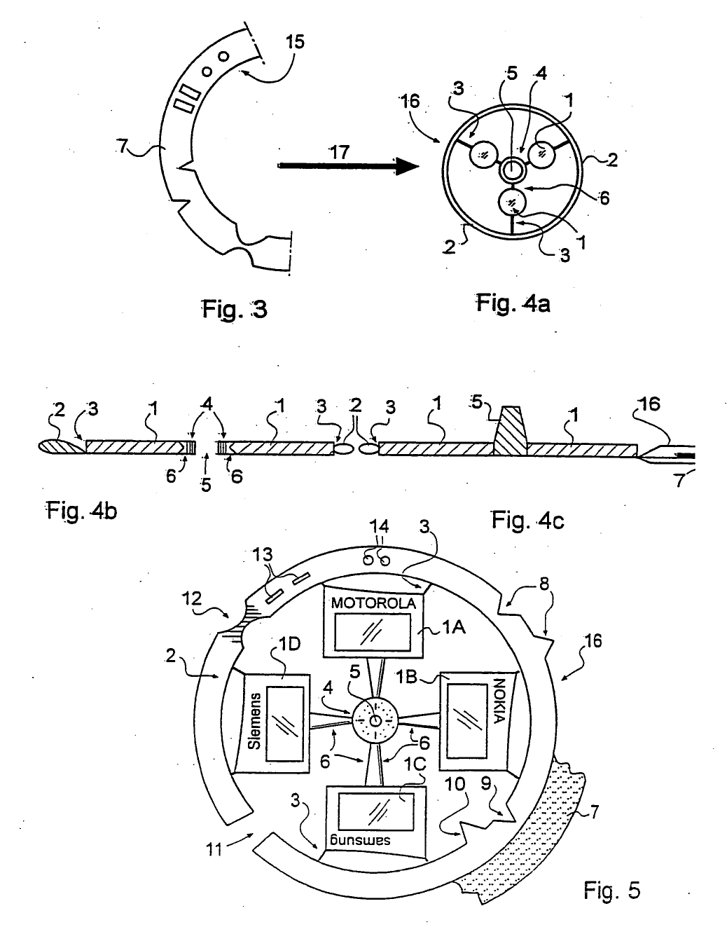

FI patent application 19992531 and PCT WO 01/38064 A1, filed by the same applicant, disclose a method in which, during manufacture of a work piece in an injection-moulding process, the work piece adheres to shafts (pins) by means of a projection. The work piece is fixed to shafts provided on both sides of the work piece using said projections. When the injection-moulding process is completed, the work piece can be removed from the mould without touching it, because the work piece has adhered to said shafts. The shafts, in turn, are fixed to a chain at regular intervals. Said chain may be of bicycle chain type or a belt, for instance. The PCT specification discloses on page 9 a method, in which the work piece 907 is formed between the moulds 903a and b, showing how the product 907 proceeds to further processing, at least through permanent varnishing 911 and UV light varnish setting 913. FIG. 3 shows the method in greater detail, in which the essential feature is that the work piece 307, having a print 308 and an optical surface 309, has been fixed to the conveyor shafts 304 and 305 by means of clamps 310 and 311, which have been formed in the injection-moulding process during the manufacture of the work piece 307.

The shafts 304 and 305 are fixed to the conveyor chain 302, of which there are two, i.e. one at both ends of the shafts 304, 305.

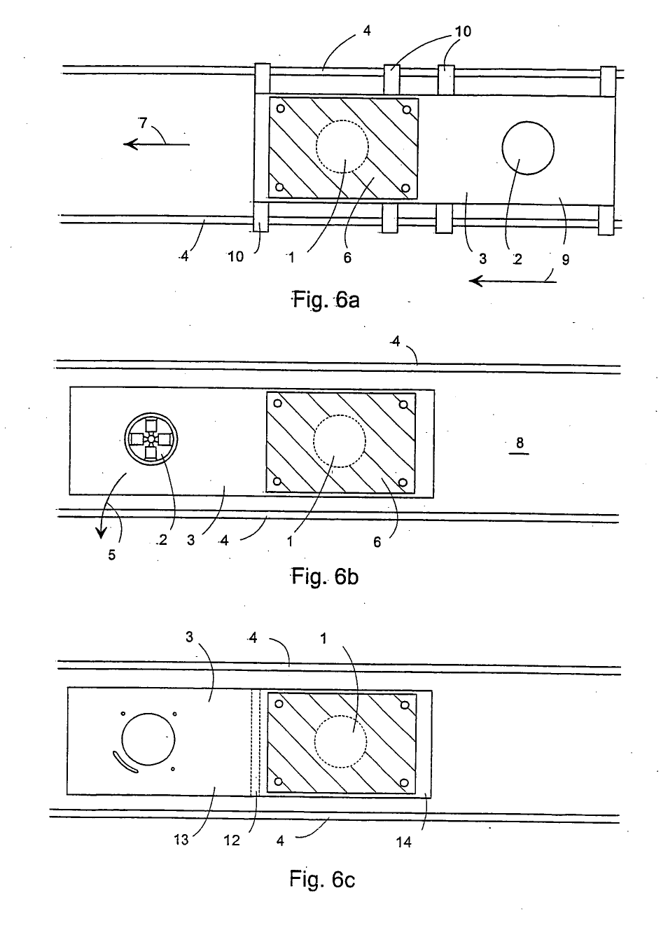

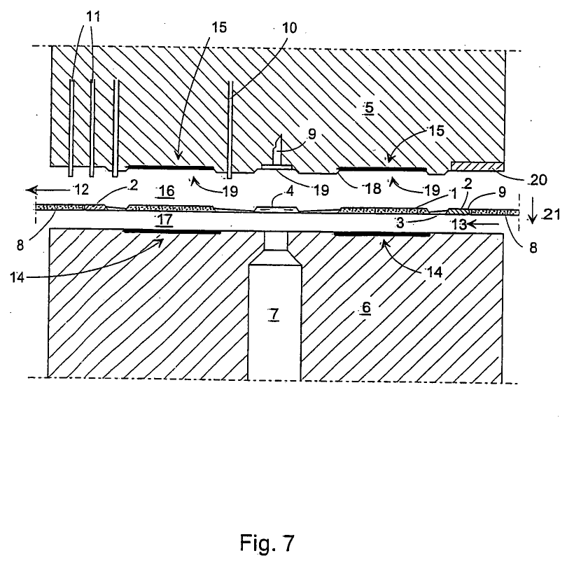

The reference also mentions that the shafts FIG. 6a-d and FIG. 7a-f may be shaped in different ways.

The essential feature of this invention is that the work piece is formed only by the injection-moulding method between two shafts and that it is fixed to the shafts over a projection, and that the shafts are fixed to a chain.

Firstly the difference of the new invention is that this invention does not comprise shafts (pins) fixed to a chain, which would consequently form a conveyor proceeding as such from the injection-moulding process to further processing. Technically speaking, this is quite a different method compared to the new invention. The proposed new method PCT WO/01/38064 A1 also involves a number of practical problems. The first of these consists of the fact that, in the injection-moulding step, a small amount of plastic always adheres to the shafts to which the work piece is fixed with the projections, and subsequently, as the shaft passes between the mould segments again, the mould segments close and the plastic surplus is crushed, with the dust thus produced spreading all over the mould surface and destroying the product. Considering that there may be up to hundreds of shafts, the only solution to the problem is checking and cleaning each shaft each time the product is removed. This is obviously a sufficient reason why the proposed method is not suitable for manufacture of products requiring further processing, such as manufacture of optical products, in which one single 1μ dirt particle is enough to contaminate the product.

A second big problem is the fact that all the different work steps need to be mutually synchronised, and especially with regard to the injection-moulding process, in other words, the problem here is that there is a common conveyor but several different work processes of varying lengths.

A third problem is that there are processes, such as vacuum evaporation, in which the conveyor needs to be introduced, and then metal particles adhere to the conveyor and the shafts. When the shaft enters the mould, the particles come off onto the work piece surface, with disastrous consequences.

A fourth practical problem is that, each time the conveyor gets to a turning point or is turned e.g. 90° about a wheel, the other side of the product must be detached from the shafts, which is not a practical arrangement.

There are additional work methods also based on placing a work piece in a chain-like space.

U.S. Pat. No. 5,478,051 discloses a method in which plastic parts to be injection-moulded form a strip after injection-moulding, a separate reinforcing wire in the strip passing through cast blocks and connecting successive parts. The specification discloses both embodiments in which the wire is formed of the same material as the work pieces to be injection-moulded and embodiments in which the wire is a metal wire, for instance. Similar solutions are also disclosed in U.S. Pat. Nos. 4,008,302 and 3,192,298.

The patents mentioned above relate to coating of a work piece by the “spin coat method”, representing but one state of the art, a method of coating work pieces. Other methods comprise permanent varnishing, piezoelectric spraying, compressed-air coating, tampon printing.

The spin coat method per se has been used since long and is well known, the applications mentioned above representing different options of the spin coat method.

The spin coat method will be referred to below in connection with the actual new method, because the new method can be advantageously suggested precisely together with the spin coat method with regard to coating.

The spin coat method has been described in the following patent applications: U.S. Pat. No. 5,395,649, PCT WO-0017118, U.S. Pat. No. 6,025,012, U.S. Pat. No. 5,945,161, DE 19545573 and U.S. Pat. No. 5,395,649.

### NEW INVENTION

The proposed new invention allows the use of quite new methods in the manufacture of products subjected to further processing.

Using the new method, it is possible to integrate further processing steps in the physical manufacturing process of the product. This is essential, because the work processes, starting from the physical manufacture of the product, e.g. a plastic injection-moulding process, to the packaging of the product, are usually carried out in a clean room.

The first reason for this is that the work piece shall be totally (100%) free from foreign objects, such as dust, dirt, grease, contact traces etc., in other words, this step requires a clean room, because foreign objects contaminate further processing steps and thus also the work piece. Secondly, all further processing steps are usually such that absolutely require a clean room.

For the new invention to be more exactly examined, one should start by studying the manufacturing methods of the (A) product, the work piece and (B) the further processing steps.

A. Methods for Manufacturing the Work Piece

1. Plastic injection-moulding method

2. Plastic cold forming methods

3. Plastic hot-forming methods

4. Metal hot- or cold-forming methods e.g. deep drawing, pressing, punching etc.

5. Metal pressure-casting methods

6. Plastic dead mould casting methods

7. Other manufacturing method of other plastic and metal than the substances mentioned

8. Plastic injection-moulding in metal casing

9. Use of an in mould-film in an injection-moulding process

10. Laminating methods

11. Combination of one or more of the methods mentioned above

B. Further Processing Methods of a Work Piece

1. Printing and coating methods, e.g. logos, figures, casing texts, lens texts, frame etc.

piezoelectric spray method

tampon printing method

screen-printing method

other printing method

spin coat-coating method

2. Scratch-Free Coating

using a chemical substrate (e.g. varnish, in liquid form)

using vacuum technique, vacuum evaporation method (e.g. glass or other material, generally on plastic)

3. Anti-Reflective Coating

usually using vacuum technique

also chemically, e.g. by varnishing

4. Connecting an External Piece

e.g. a tape for adhesion

any other part, e.g. connecting an external part by ultrasound welding or gluing

5. Surface Working

by laser, e.g. varnish removal from the work piece parts subsequently subjected to ultrasound welding.

6. Checking the work piece

optically

using various gauges

reaction check, e.g. ensuring that the UV varnish has cured

7. Forming Outer Surface

vacuum metallising method

painting

mechanical engraving

laser engraving

laser burning

other

8. Providing a Protective Film

on the work piece, e.g. on an optical lens surface

9. Packaging

in plastic folders

in wound form

in cassettes

10. Removal of Work Piece from Worktable and/or from Each Other for Packaging

11. Other Further Processing Steps of a Work Piece, which are not Usually Integrated in the Physical Manufacture of the Product, but to which the Same Rules Apply as in an Integrated Manufacturing Method

electric catalytic coating

chemo-electric catalytic coating

Further Processing Steps of a Work Piece

Consequently, the methods for manufacturing the work pieces (A) or the further processing methods of the work pieces are not essential in the new invention, but the manner of implementing prior art methods using the invention.

The new invention comprises two essential parts: forming the work piece, transfer and use of the work piece in processes (A), and (B) above, and removal of the work piece from the manufacturing process (item A), e.g. in a plastic injection-moulding or dead mould casting-process.

The objective of the new invention is to provide an automatic method for manufacturing a work piece, e.g. an optical lens, in which the work piece manufacturing methods can be implemented under A and the work piece further processing methods can be implemented under B.

The major bar to elaborating manufacturing and further processing methods has always been due to the different physical dimensions and shapes of work pieces. Also, it should be considered that the age of work pieces, i.e. the products, implying the period over which they are for sale and in production, is extremely short nowadays.

Hence the different manufacturing methods A and further processing methods B described in the application require the production line to be repeatedly changed, causing higher prices of the products and reducing production quantities.

For work pieces to be transferred and used in different manufacturing and further processing steps, the work piece should be a standard piece always remaining the same regardless of the product and its physical dimensions and shapes.

An essential part of the application is this standard, the way of forming it and the way it allows the work piece to be transferred, removed in the manufacturing process of the work piece, e.g. in a plastic injection-moulding process.

A number of essential parts of the new invention have been described in FIG. 4a-c, where the work piece, the actual end product 1 desired, regardless of its physical dimensions or shapes, or the number of these, has been placed inside the periphery of the work plane 2, where there is an “inner periphery” 4, having a hole (FIG. 4c), e.g. a pin 5 in the centre.

The work pieces 1 communicate with the inner periphery 4 over projections 6 and with the outer periphery 2 over projections 3; variations of this will be described more in detail below.

It is essential for further processing B and the manufacturing process A to have a standard, regardless of the dimensions or shapes of the workpiece.

This standard is a hole 5, having a diameter of e.g. 8 mm and an outer periphery of e.g. 160 mm, with the desired work pieces placed between the hole 5 and the outer periphery 2.

There may be many such standards, e.g. 3. The hole 5 always has the same location, e.g. always in the centre and with an 8 mm size, but the outer periphery 2 may be e.g. 120 mm, 160 mm and 200 mm depending on the product dimensions.

For clarification of the different part areas, FIG. 4 is taken as an example from here on. The work piece 1 is the part desired as the end product, e.g. a lens. The outer work plane 2 is the periphery, inside which the actual products, the work piece 1, are located. The inner work plane 4 is the area, in the middle of which there is a hole 5 or a pin. The projections are the parts 3, 6, connecting the work piece 4, which may comprise several products, with the outer work plane 2 and the inner work plane 4.

In the new invention, at least an inner work plane 4 has been formed, which comprises a hole and in which the work piece 1 is fixed directly or over a projection to said inner work plane 4.

It is an advantageous feature of the invention to comprise also an outer work plane 2, because this facilitates markedly the manufacturing process and the further processing steps.

In the embodiment described, all the part areas (FIG. 4 1-4 and 6) are made of the same material and have been formed in the same work step, e.g. in a plastic injection-moulding process.

In the most straightforward embodiment, the inner work plane (FIG. 5) 4 is continuous and has a hole 5, which has been formed at the place where plastic, for instance, has been injected into the mould and removed by lathing or milling, so that said hole 5 has been formed, and that the outer work plane 2 is continuous. The products 1A-D have been placed between the outer work plane 2 and the inner work plane 4.

There will obviously be material waste compared to currently known methods, in the range of 5 to 15%, but on the other hand, the product yield is 100%, versus only 50% currently, and even less for optical products.

On the other hand, all the parts that do not pertain to the actual work piece and are removed after all the work steps have been performed, i.e. the outer work plane, the inner work plane and the clamps, can be crushed and recycled for manufacturing cover parts, for instance. In this case, there will be 0% waste of material, while the yield is extremely high.

In the method of the new invention, comprising an outer and an inner work plane having a hole and allowing one single dimension to be obtained, all the different work steps can be standardised, in other words, there is no need to build or change production lines in any way.

This applies to all the processes, from the forming of the product e.g. in an injection-moulding process to the last further processing step.

The method for manufacturing a CD-disc is effective and produces flawless pieces precisely because it has surfaces that can be touched, an outer frame and an inner frame with a hole. Between these there is a data storage area, which must be 100% correct. In a method for manufacturing a CD disc, all the work steps depend on the fact that the CD disc actually has the required hole at the required location and that its outer dimensions are as required.

On principle, the method of the new invention utilises the same features a standard outer periphery and inner periphery having a hole, with the difference that the products are placed between these areas in the new invention.

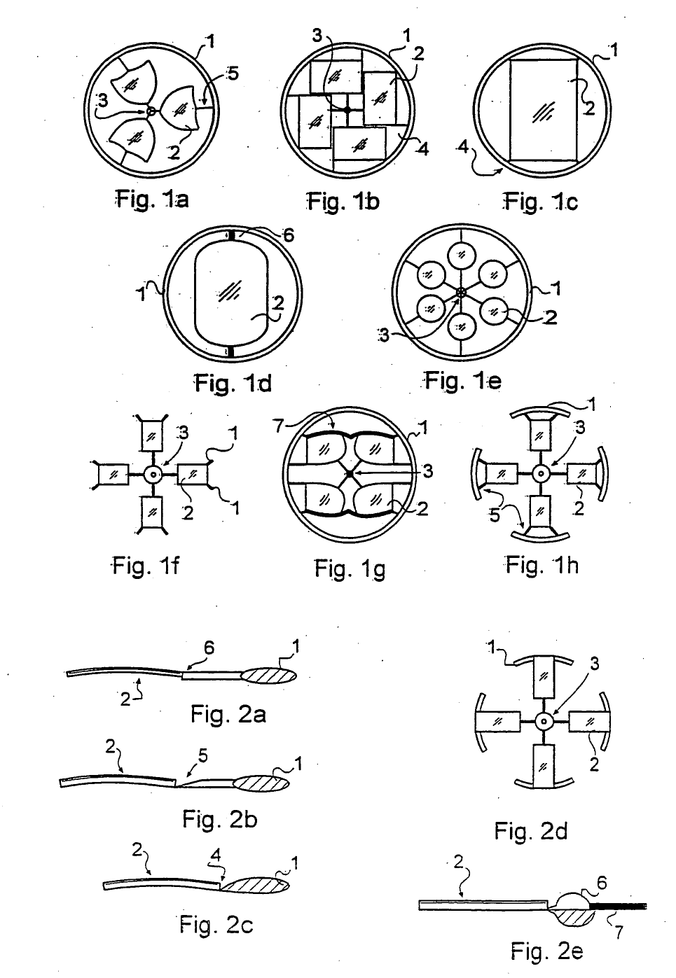

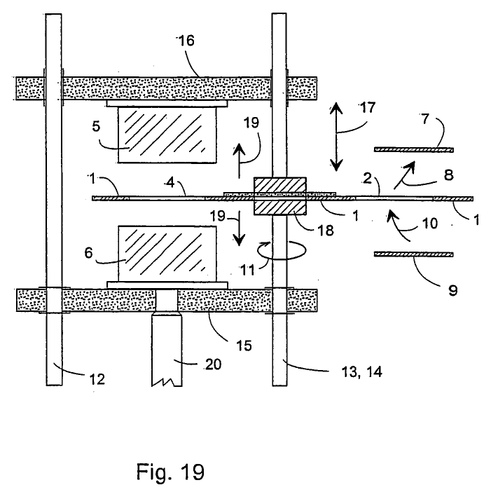

The new invention and its manufacturing method are shown in the following FIG. 1→FIG. 17→FIG. 19.

All the figures use an optical product, such as a mobile phone lens, as an example. The invention obviously relates also to other products, however, the invention is advantageous in fields requiring several further processing steps after the manufacturing process. A mobile phone lens is precisely such a product.

FIGS. 1 to 5, FIGS. 9 to 10 show shapes of the work piece of the invention allowing the work piece to be transferred between the different work steps, and examples of a number of transfer methods and manufacturing methods of the invention in FIGS. 6 to 8 and 11 to 19.

FIGS. 1a to 1h and 2a to 2d show the position of the actual products 2 in the work piece, where, in the method of the new invention, there is at least a centre 3, from here on referred to as inner work plane, and a frame 1, referred to as outer work plane below. The attachment of the actual product, e.g. a lens 2, to the inner 3 and outer 4 work plane is also illustrated.

The goal is to have one single standard shape and dimension of the inner 3 and outer 1 work plane. A shown exception is a very large product 1c and 1d2, and then only one method of the new invention is used, the outer work plane 1, which acts both as a centring part and as a clamp, as an adhesive surface and for determination of the x-y coordinate. The method of the invention is characterised by the fact that, in the manufacture of the work piece with a moulding process, the mass is injected into the mould in the centre of the work piece, i.e. through the inner 3 work plane. In exceptional cases, FIGS. 1c and d, this location is another, e.g. a clamp member 6 in FIG. 1d.

In FIGS. 1a, b, c, d, e and g, the outer work plane 1 may act independently in the different work steps, whereas FIGS. 1f, h and FIG. 2d require the use of a separate external work plane, e.g. an auxiliary metal work plane in the manufacture of a CD disc. It should be noted that this could be the procedure also in FIGS. 1a-e and g, although these have an outer work plane 1 already existing when the work piece is being formed.

FIG. 1g represents a situation, where a two-component injection-moulding method has been used in the manufacture of the product, 1, 2 and 3 being made of the same material and 7 of a different material.

FIGS. 2a-c show the attachment of the actual product 2 to the outer work plane 1, and then the clamp 6 in FIG. 2a has the same thickness as the outer work plane 1. In FIG. 2b, there is a notch 5 in the clamp close to the desired product 2, where the work plane 1 in FIG. 2c contacts the product 2, and a notch 4 close to the product.

FIG. 2e differs in not having an outer work plane 1, but the clamps 6 are attached to the auxiliary plane in the manufacturing step, e.g. an injection-moulding step, so as to block the work piece forming the product 2, the inner work plane 3 to the auxiliary plane 7, which may be made of metal, cf. FIG. 10.

FIGS. 3, 4 and 5 show parts and functions of the work piece of the invention, with the product 1 located inside the outer work plane 2 and the inner work plane 4, which either an intact plane 4 as in FIG. 4b, in which a hole 5 bas been lathed or otherwise formed after or during the manufacturing process, or a projection 5 as in FIG. 4c, in the form of a pin or a shaft, for instance.

The products 1 are fixed to the outer 2 and inner 4 work plane with clamps 3 and 6, which are made of the same material and simultaneously with the work piece. Both the outer 2 and the inner 4 work plane have the purpose of avoiding touching of the desired product 1, e.g. a lens, at any stage of the manufacturing process.

The shape of the outer edge 10 of the outer work plane 2 is primarily affected by the manner in which the work piece is removed from the manufacturing process, e.g. from a plastic injection-moulding process.

A typical series of shapes is shown in FIGS. 2a-c, in which 12b the shape, the outer edge 9 of the outer work plane 2 is the same as in CD-DVA discs. This enables the work piece to be removed from the manufacturing process, e.g. an injection-moulding process, without having to touch the actual end product 1.

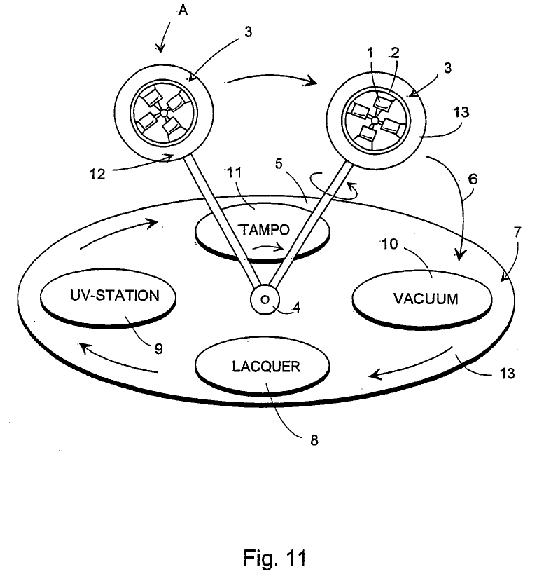

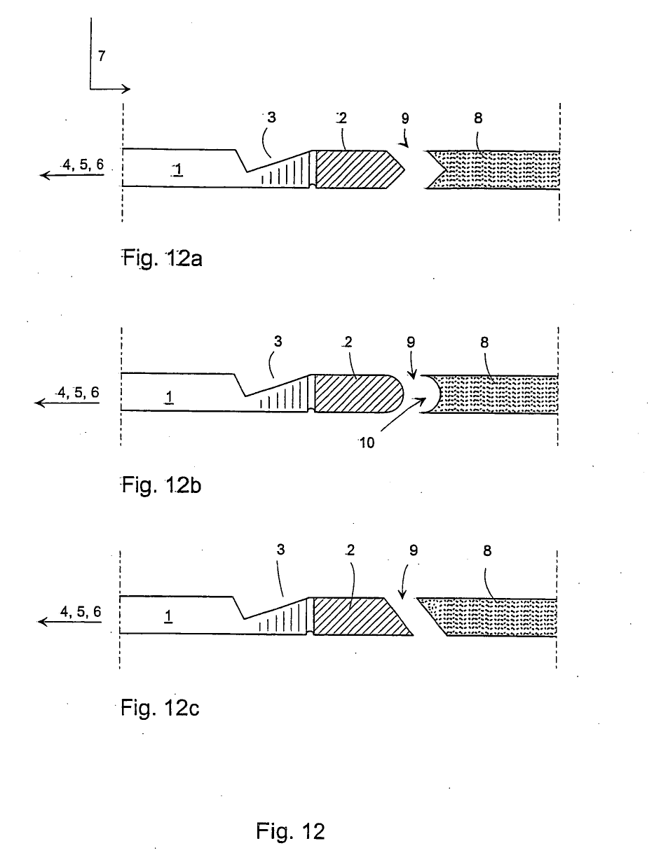

The process may relate to a metal ring, FIG. 11 3, inside which the work piece 1 is placed and in which the outer edge of the outer work plane 2 of the work piece 1 is adapted to the inner surface, FIG. 12b 10, of the auxiliary metal work plane 8 in the manufacturing process.

In FIG. 7, the work piece and its outer work plane 2 are locked to the auxiliary work plane 8, because the edge of the “auxiliary work plane”8 is negative. The work piece is easy to remove, because the work piece shrinks in plastic injection moulding, for instance, and can thus be removed controllably and easily from the auxiliary metal work plane 8.

In the manufacture of a CD disc, a similar manufacturing method has been typically applied, FIG. 11, in which the outer work plane 2 of the work piece is inside the closed metal ring 3.

A CD disc does not literally speaking have an inner or outer work plane, since all the areas are part of the product, however, in the method of the new invention, the inner and the outer work planes are not part of the product, but are removed from the product when all the work steps are completed.

FIGS. 3, 4 and 5

The outer work plane 2 has also other functions than removal of said work piece under control from the manufacturing process, e.g. a plastic injection-moulding process. One of its central functions is to keep the work piece assembled during further processing steps.

FIG. 5 shows a typical case, where the products 1A to 1D are placed inside the work plane 2, fixed to the work plane 2 by means of projections 3 and fixed to the inner work plane 4 by means of projections 6.

The outer work plane 2 has other functions as well, such as 8 a projection or a notch on the outer surface of the work plane 2 or accordingly, a notch 9 and a projection 10 inside the work plane 2. The outer work plane 2 may also be discontinuous at one or more locations 11, i.e. completely interrupted, and the work plane 2 may have different shapes 12. There may also be different areas forming identification points, such as holes, recesses, projections 13 and 14, which are essential if positioning is done using the outermost work plane 2. Positioning of the work piece is essential for the different further processing steps, such as e.g. printing. The areas described serve for exact definition of the x, y coordinate of the product each time.

FIG. 3 shows a separate auxiliary metal work plane 7, which is also typical in the manufacture of a CD disc, and the functions shown in FIG. 5 may also be included in this the auxiliary work plane 7.

FIGS. 4b and c show a cross-section of FIG. 4a.

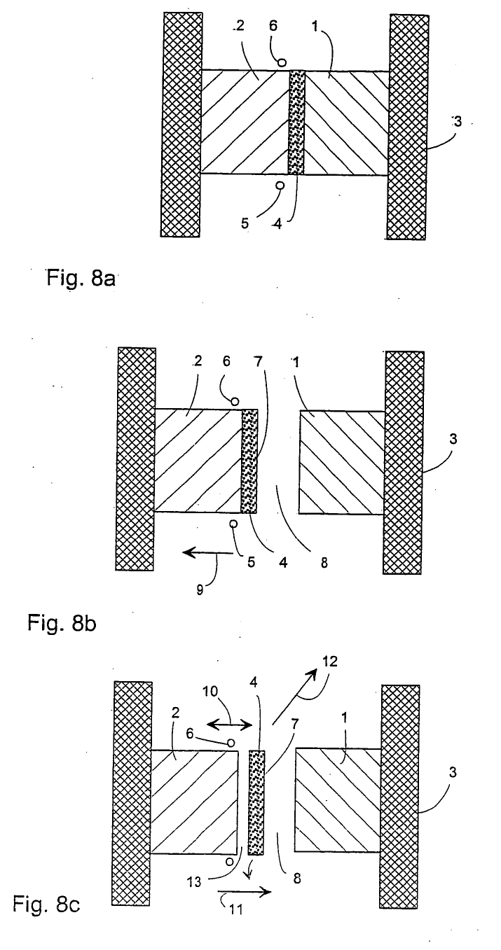

FIGS. 6a-c from the front and FIGS. 8a-c from the side.

The figures show the manufacture of the work piece to be produced in the injection-moulding step and removal of said work piece from said work process for further processing.

The method for transferring a work piece of the invention, FIGS. 6, 7 and 8, differs essentially from the one typically used in current methods for manufacturing CD discs, shown in FIG. 4, in that the new method for removing the work piece from the injection-moulding process is lineaily operating.

FIG. 6a shows the linear plane 3 of the linear transfer method of the new invention, having two holes 1 and 2, having a size and a shape allowing the work piece of the invention shown in FIGS. 1 and 5 and 12 to be formed.

The linear plane 3 is fixed with glide clamps 10 to at least one linear guide 4, yet two linear guides 4, as shown in FIG. 6, would naturally provide a more solid arrangement.

The linear transfer method operates on the following principle when the work piece is manufactured, one of the holes 1 in the linear plane 3 is at a precise position in the mould 6, and the work piece can now be formed. Simultaneously, the second hole 2 of the linear plane 3 is outside, when the product is finished, the linear plane 3 moves to the left following the arrow 9, and the free hole 2 gets inside the mould 6.

FIG. 6b shows a situation where the manufactured product, FIG. 6a, is finished and the linear plane 3 has already passed outside the mould space 6 and the work piece 5 can be withdrawn, leaving the space 2 free.

The linear transfer method described is more accurate and rapid than the currently available transfer method shown in FIG. 11.

The illustrated linear plane 3 may be continuous, FIGS. 6a and b, comprising two holes, or it may consist of two separate planes 3 and 14, which are fixed to the same guide 4. The functions are entirely synchronised. 12 shows the interface between two linear planes 13 and 14.

FIGS. 8a-c show a side view of the linear transfer system, 3 being the mass spraying direction, i.e. the stationary part of the frame wall of a plastic machine.

In FIG. 8a, the mould segments 1 and 2 are closed, and between them there is an area/part of a linear plane 3, FIG. 6, within which the work piece is formed.

FIG. 8b shows the step following completed plastifying of the work piece. The mould segment 2 opens by 5 mm, for instance, yet the linear plane 4 is still in contact with the mould segment 2. The work piece is in contact with the linear plane 4, which, in turn, is in contact with the guides 5 and 6. Opening the mould segment 2 in the direction of the arrow 9 takes about 120 to 200 ms.

FIG. 8c shows the last step before the linear plane 3 can be transferred, and in this context, it is essential to know the reasons for the various moves and the difference between transferring a CD disc, taken as a reference object, and the work piece of the invention. The difference is simple. A CD disc is evenly flat, usually with a 0.9 mm thickness and a 120 mm diameter, and it has no hole during removal, so that it is extremely easy to detach and remove.

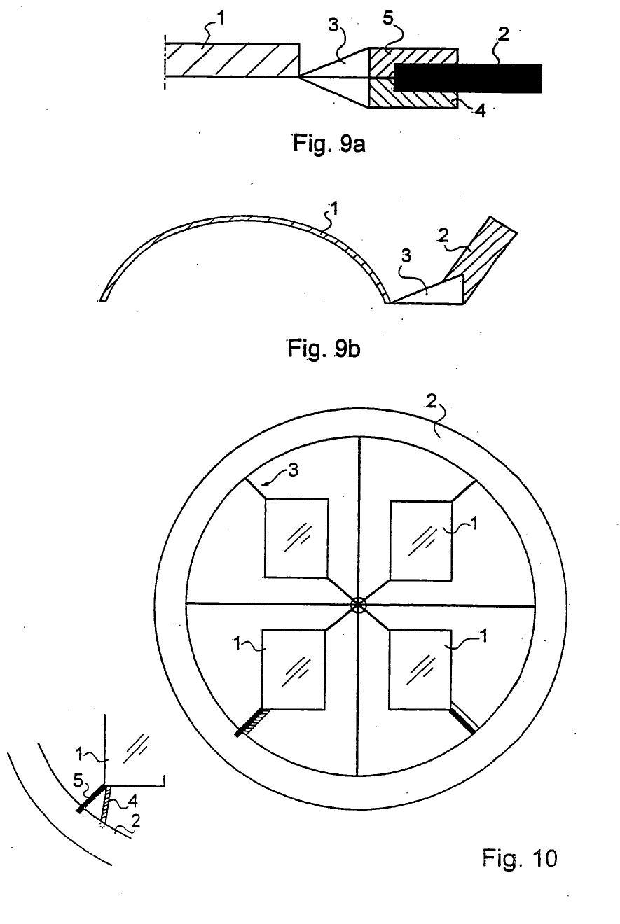

The new method of the invention does not involve this problem, given the outer or inner 4 work plane in FIG. 5 identical with that of a CD disc, by contrast, the problem is caused by the space formed between the outer 2 and inner 4 work plane, which consequently is of the same material as the mould, resulting in the necessity to move the work piece 1 at least over this thickness out from the mould surface. Additionally, one should note the shape, i.e. the different depths of the work piece, e.g. FIG. 9b, in which the actual product 1 of the work piece is convex. If the convexity has a 7 mm depth, the work piece needs to be moved over a distance including at least this dimension plus a safety gap of 1 mm outside the mould surface.

FIG. 8c signifies that the linear plane 4 should first move away 11 in the direction of the arrow at least over the depth of the product plus a safety distance 8 into the opposite mould segment 1, i.e. the space 13 should preferably equal at least the depth of the product. The linear plane 4 is fixed to the guide 6 in such a way that, even if the guide 6 is stationary, the linear plane 4 may move 10 in the direction of the arrow, i.e. away from the mould surface contacting the linear plane in the segment 2.

Subsequently, the linear movement can be made e.g. as shown in FIGS. 6a and b.

The movements of the linear plane 4 can be synchronised, FIG. 8, with the movement of the mould segment 2, which takes 120 to 200 ms. At the end of 250 to 400 ms, there will be a new empty linear transfer plane between the mould segments.

FIG. 7 shows more precisely the work step of FIG. 8c, where the work piece is disposed in the hole in the linear plane 8, the edges 9 of the hole being adequately shaped for the work piece to be retained in the hole. The work piece is preferably placed exactly as shown in FIG. 7, with the inner work plane 4 in the centre of the mould, directly opposite the hot channel 7 of the mould. With this disposition, plastic will flow simultaneously and identically to all the parts of the work piece.

To detach the work piece from the mould segment 5 and the mould chambers 19, one can use known methods, such as compressed air removal 9 or ejection pins 10 and 11. This is precisely one purpose of use of the outer 2 and inner 4 work plane. These very work planes can be chosen as ejection sites, thus avoiding touching the product 1.

Cooling of the mould can be optimally arranged at the mould surfaces 14 and 15 located at the product. In the absence of the work planes 2 and 4 described, the actual product area would necessarily be taken as ejection site, as is the current practice, and this is a very detrimental operation regarding cooling.

For optical products, optimal cooling is quite crucial for successful manufacture of the product.

Using the new method of the invention, it is also conceivable to adopt a “ring removal method”20, in which the outer work plane 2 and the linear plane 8 act as contact surfaces.

If the invention is implemented using the ring removal method 20 above, with the inner work plane 4 being removed on the compressed-air plane 9, the mould can have a standard design in other respects, except for the product 1.

FIGS. 9a and 10 show one embodiment of the new invention, where 2 is a separate auxiliary metal plane, which has been disposed in the mould and contains an injection-moulded work piece 1, with the adjacent clamps 3 interlocking the auxiliary metal plane 22 from two directions 4 and 5. This keeps the product very firmly in position, while it is easy to detach.

FIGS. 12a-c show the linear plane 8 and different profiles 10 of the edge 9.

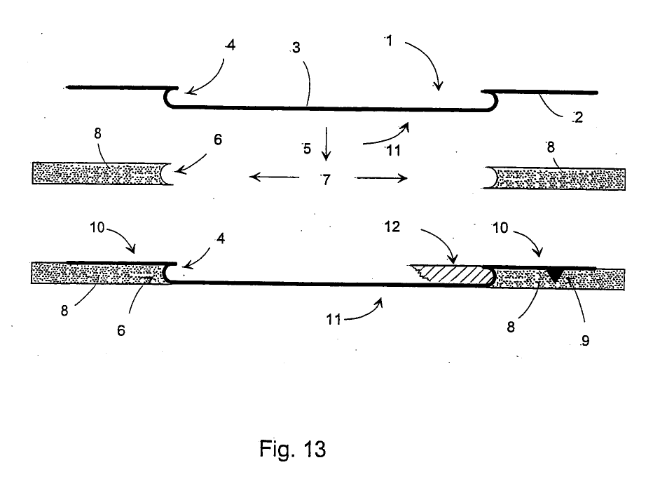

FIG. 13 shows one embodiment of the method of the new method, the in-mould film 1 and its use for the manufacture of injection-moulded work pieces.

The use of an in-mould film per se has been long known and largely used.

The in-mould film, FIG. 13 1, has been shaped in advance so as to correspond to the shapes of the product, and additionally in this case, so as to fit into the opening 7 provided in the linear plane 8.

Thus, after the in-mould film 1 has been shaped, it is inserted in the opening 7 in the linear plane 8 so as to firmly engage the edge 6 of the linear plane 8 in the direction of the arrow 5. Since the in-mould film 1 has been shaped with a similar edge 4 as the edge 6 of the linear plane 8, the in-mould film 1 will be firmly retained in position during the injection-moulding process 12 and during removal of the work piece on the linear plane 8 from the plastifying step.

The in-mould film 1 may also be fixed and positioned at some other location than the edges 4. It is also possible to use some other point of engagement 9 than the border area 4 shown outside.

The use of an in-mould film is advantageous, because the in-mould film can be formed with an anti-reflective surface using the vacuum method, it can be provided with ornamental surfaces using vacuum evaporation methods, figures can be printed on it, etc. Especially using the spin coat method, as in the manufacture of a CD disc, it is preferable to use an in-mould film.

A study of the design of the work piece of the new invention in FIG. 5 reveals that the space between the outer 1 and the inner work plane 4 and the actual products 1A-D is empty, i.e. devoid of material, which, in-turn, means that the work plane 2 and its internal area are not continuous, i.e. intact.

This would prevent the use of the spin coat method, which has proved beneficial, in varnishing, for instance. Varnishing is compulsory if one aims at a scratch-free surface of the product.

In FIG. 13, the in-mould film 1 forms a continuous surface on one side of the work piece, i.e. the outer work plane 2 in FIG. 5 and its internal area.

A work piece thus manufactured can be coated and treated in any work processes exactly as a CD disc.

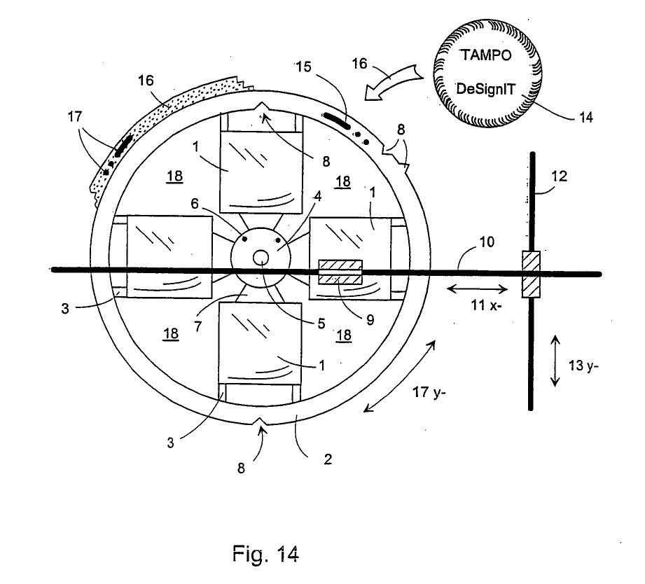

FIG. 14 shows printing of the product parts 1 of the work piece, using e.g. a piezoelectric spray head 9 or tampon printing 14. Regarding both the printing methods, it is essential to know the position of the work piece and the position of the product parts 1 to be printed. As noted above, the work piece has two standard areas, an outer 2 and an inner 4 work plane, where the areas 8 and 6, and also 15, enabling positioning of the work-piece, are located.

A coating method operating with a piezoelectric spray head has the most straightforward operation when placed in at least one linear guide 10, which allows getting the x direction. The y direction is obtained either by reciprocating 17 the work piece or moving it with continuous rotating movements or by using a second linear guide 12, which allows 13 movement in the y direction.

A work piece can also be coated with protective varnish in the manner described above.

The tampon printing 14 described above also requires exact positioning of the work piece in the x and y directions, given the single path 16 of the printing pad in tampon impression, or else unreasonably expensive robotics would be required.

If the work piece is the one shown in FIG. 10, for instance, with the outer work plane 2 separate, FIG. 14 also 2, the positioning may be 17 in this case as well.

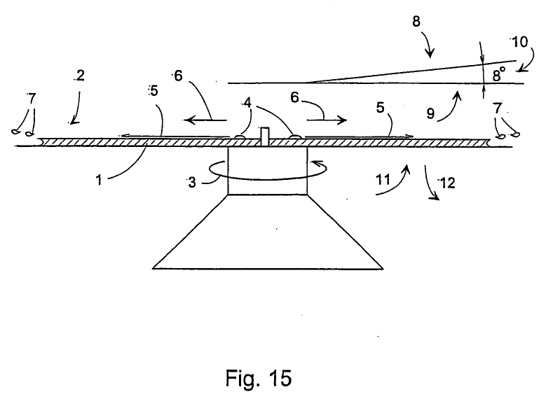

FIG. 15 shows the spin coating method, which is previously known and commonly used in the coating of CD and DVD discs, for instance. Coating provides a scratch-free surface on the side of the work piece on which the laser read head reads stored data.

There are many versions and improvements of the original spin coat method, e.g. U.S. Pat. No. 5,395,649, filed by the Japanese Sony Corp., represents one of these.

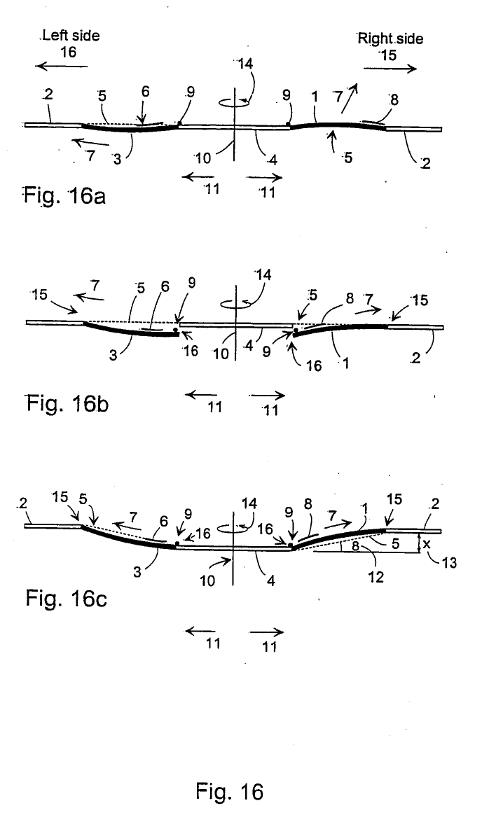

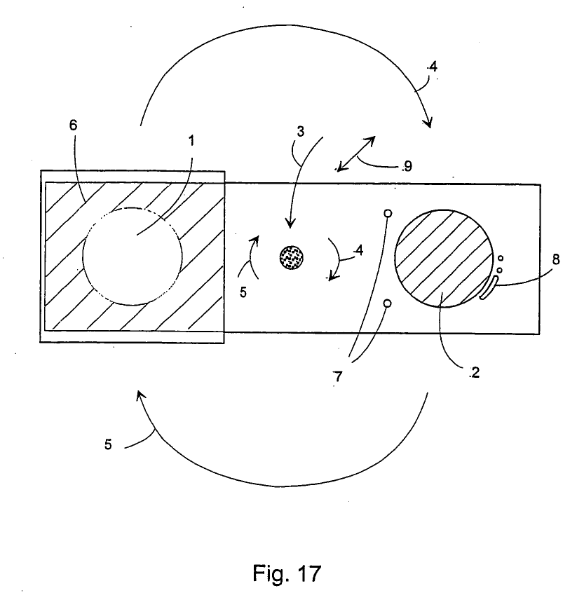

The detailed shape of the work piece shown in FIG. 15 has been described repeatedly above. FIG. 15 deals with the general operation and improvements to this as shown in FIGS. 16b and c. Both FIGS. 15 and 16 are still spin coat methods.

The idea of the spin coat method is the following: with the work piece in position, it is coated with a coating agent, e.g. a UV curing varnish 4, in a circle at the centre or close to the centre of the work piece, provided that there is a hole in the centre of the work piece, as is the case of a CD disc. Subsequently, the work piece is brought into rotation 3, during which the varnish 11 is applied as an even surface 5 in the direction of the arrow 6 under the centrifugal force.

The method of the new invention states that the in-mould film 2 covers entirely the work piece on the side where the varnish is applied. Unless the surface is intact, varnish would escape out of control through the openings 11 to the plane under 12 the work piece, and this would not be adequate. Owing to the centrifugal force, excess varnish 7 is removed from the work piece, with the desired even varnish surface remaining.

FIG. 15 shows an even flat work piece, yet the work piece may also be concave or convex. In terms of the work process, the work piece preferably has a shape as the one shown in FIGS. 16b and c.

FIG. 16 shows the problem caused by a spin coat method if the work piece has a shape other than straight or almost straight, e.g. a concave 16 left side or a convex 15 right side. The problem is the following: the coating agent, being in liquid form at the centre 20 or in a circular space 9 around the centre, does not spread on the surface 6 inclined in the other direction, at a negative angle 3 to the plane 5, left side 16. A similar problem arises if the product 15 has a convex right side 15, then the varnish 7 tends to escape from the surface 8 inclined away from the plane 5, i.e. at a negative angle. This follows the laws of physics when a coating method based on the centrifugal force is used, as is precisely the case of a spin coat method.

FIGS. 16b and c show a solution to the problem of FIG. 16a, for applying a viscous substance, such as liquid varnish, evenly on all the surfaces using the spin coat method, the work piece having a shape other than straight, convex or concave, for instance.

The principle of this solution is that the surface to be coated, FIG. 16b 1 and 3, are positioned such that the punctual area 9 where the varnish is applied closest to the centre 10 is on a level lower or identical to the outermost surface 15 of the product. Then a liquid coating agent, e.g. a varnish 6 and 8, is always forced to pass on the surface of the product.

In FIG. 16b the products 1 and 3 to be coated, which have a shape other than a straight plane, are placed with the lowermost point 16 of the products 1 and 13 to be coated closest to the central point 10 and the uppermost point 15 being always the outermost point. The varnish is naturally placed 9 on the surface of the product 1 and 3 to be coated that is closest to the central point 10. In the shown FIG. 16b, the outer work plane 2 and the inner work plane 4 form a planar surface 5 and the inner part of the products 1 and 3 is lower 10 than the planar surface 5 and the outermost plane 15 of the product is on the same level or higher than the outer work plane 2. The planar surface 5 signifies the o-coordinate on the y plane of the height, and then the study is started from the area represented by the inner work plane 4 of the work piece.

The solution of FIG. 16c follows the same principle as in FIG. 16b. The products 1 and 3 have been positioned in the work piece with the lowermost surface 16 of the product closest to the centre 10 of the work piece. It is essential for the invention that the inner work plane 4 lies lower than the outer work plane 2 and that the inner part 10 of the product is the area of the product 3 and 1 closest to the centre 10 and on the same level as the work plane 4 and positioned such that the highest point 15 of the product 1 and 3 is on same level as the work plane 2 or on a higher level.

The planar surface 5 rises from the inner work plane 4 towards the outer work plane 2, which thus lies higher than the inner work plane 4 surrounding the centre 10. Then the angle 12 of the planar surface 5 is larger than 1° compared to the starting plane 17, the inner work plane 4 in the present case. The liquid coating agent, varnish 9, for instance, is placed on the side 16 of the product 1 and 3, which is closest to the centre 10.

In both cases, the embodiments of the invention in FIGS. 16b and c result in the same end result. The coating agent, e.g. a UV cured varnish, is placed on the side 9 of the products 1 and 3 in the work piece which is closest to the inner work plane 4, or on the work plane 4 proper. When the rotational movement 14 starts, the varnish 9 tends to move outwards 7 on the periphery, i.e. away from the centre 10.

Since the products 1 and 3 of the work piece, lenses, for instance, are placed so as to form a rising angle, FIG. 16c 12, to the lowermost plane 16 of the product 1 and 3, the coating agent, varnish, is simultaneously forced 6 against the surface of the product while tending to move outwards on the periphery 7. In this manner, each surface will be evenly coated.

FIG. 17 shows an embodiment of the new invention, FIGS. 6 and 8, which differs in that the “linear” does not operate in a linear movement, but in a rotational movement.

The linear plane, FIG. 17 10, has the same design as the actual linear plane described above, FIG. 6, FIG. 7, FIG. 8, FIG. 12 and FIG. 13, with the difference that in FIG. 17 the linear plane 10, the trajectory 4 and 5 is rotational relative to the central line 3.

6 is the mould proper, in whose space the linear plane 10 is disposed, and then 1 is the space/area where the work piece is formed and 2 is the corresponding space, yet empty. 7 and 8 are positioning areas, if an in-mould film is used. As shown above in FIGS. 6, 7 and 8, the linear plane 17 should also be able to move in the direction 9 of opening the mould, because otherwise the work piece cannot be removed under control.

The linear plane 10 fixed to the central line 3 so as to allow rotational movement may be itself fixed either to the mould 1 or to the frame of the injection-moulding machine, or to the frame on a separate plane. The operation is the following: when the work piece has been completed in the space 1 formed for this purpose, the work plane rotates 180°, and then the completed work piece in space 1 is removed from the mould space 6, and similarly, the empty space/area 2 enters the mould space 6.

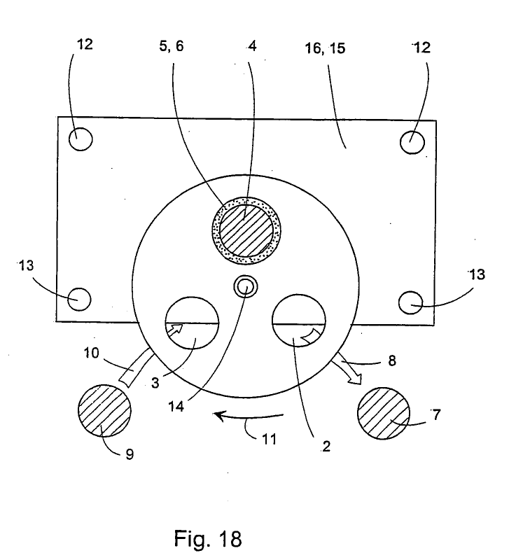

The method for transferring work pieces of the new invention differs from the linear transfer method above in that the present transfer method comprises a plane as in FIG. 18 1, which rotates around its own central axis 14, with the openings 2, 3 and 4 in the plate 1 always exactly positioned as desired.

The linear plane transfer method, FIGS. 6, 7,8 and the rotating planar transfer method, FIGS. 17, 18 and 19 have the common feature of comprising a plane with openings, in which the product is manufactured, using e.g. a injection-moulding process.

The difference lies in the fact that the movement in the linear transfer method, e.g. FIGS. 6, 7 and 8, is a straight linear one, whereas in the rotating plane transfer method, the movement is rotational.

FIG. 18 shows the new invention from the front and FIG. 19 from the side.

The basic element of the rotating plane transfer method is a surface plate 1 having openings 2, 3 and 4. The surface transfer plane in pivoted on the axis 14, which also may consist of one of the guides of the injection-moulding machine, on which it can be transferred over the desired distance 11 in the direction of the arrow 11, with the opening 4 always fitted exactly between the moulds 5 and 6.

One of the advantages of the invention is that the surface transfer plate 1 has a number of openings 2, 3 and 4 equal to the number of simultaneous work steps. FIGS. 18 and 19 show examples of a plastic injection-moulding method. In the exemplified case, the work piece may as in FIG. 5 or FIG. 10, but equipped with an in-mould film, to allow use of the spin coat method in the coating.

The work piece is formed when the mould segments 5 and 6 are closed and the opening 4 of the surface transfer plate 1 are within the mould. The product 7 is removed through the opening 2 in the direction of the arrow 8, in other words, the opening 2 will subsequently be empty. When the work piece in the opening 4 is finished, the surface transfer plate 1 rotates in the direction of the arrow 11, and then the finished product in the opening 4 passes in the direction of the arrow 11 120°, and the empty opening 2 moves to replace the opening 3, in which the in mould film 9 has been placed in the direction of the arrow 10.

Each time the surface transfer plate 1 proceeds, the mould segments 5 and 6 are in open position, as shown in FIG. 19.

In the manufacture of a CD or DVD disc, there is no need to open the mould 5, 6 to the same extent as in this method of the new invention, because the moulds are straight and without shapes. By contrast, mobile phone lenses and similar products are seldom straight. In that case, the second mould segment 5 should move far enough for the surface transfer plate 1 to describe the desired movement together with the work piece. The surface transfer plate 1 may also move in alignment 19 with the opening direction of the mould 5. The surface transfer plate 1 may be attached to a separate guide, FIG. 19 14, or to the main guide 13 of the mould tables 15 and 16 of the injection-moulding machine. Then and advantageous solution would comprise equipping the injection-moulding machine with three guides at a mutual relative angle of 120°.

The method for transferring a work piece shown in FIGS. 18 and 19 is also known by the transfer surface plate 1 being possible designed for receiving a separate auxiliary work plane, a circular metal ring used in current CD manufacturing machines.

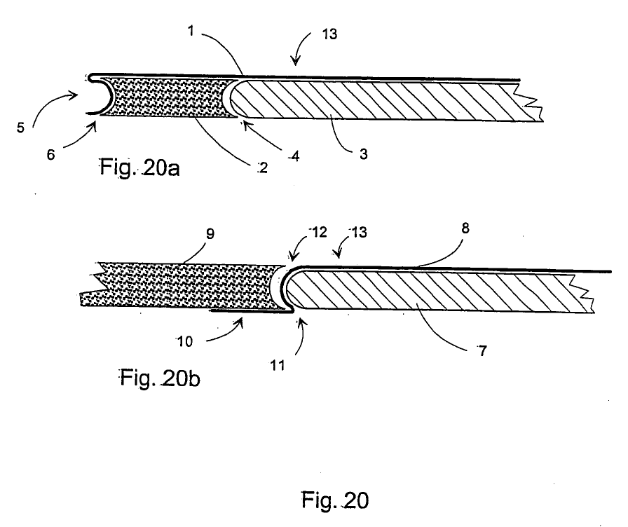

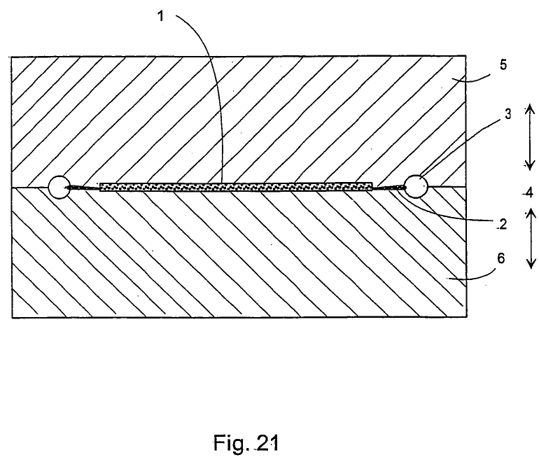

FIG. 20 shows the use of an in-mould film in the present methods for transferring work pieces, of which there are two. In the first one, the work piece is formed in the opening in the transfer plate, and on the second one, the auxiliary metal work plane is utilised as in some current CD manufacturing methods.

FIG. 20a shows a solution using an auxiliary metal work plane 2. Since the area to be coated, i.e. the upper surface 13, is preferably not ended in the area of the auxiliary work plane 2, the in-mould film 1 must continue so as to cover with its entire surface as an edge 5 surrounding the auxiliary work plane and to engage the edge 6 of the auxiliary work plane by means of the negative edge 6 shown. Here the argument is that the auxiliary metal work plane 2 must not get fouled and varnished, because it is intended for reuse, in other words, the auxiliary work plane proceeds through all the further processing steps and shall thus remain absolutely clean. The in-mould film covers the auxiliary work plane as in FIG. 20A.

FIG. 20b, again relates to a method in which the plate 9 for transferring the work piece has openings, in which the work piece 7 is formed and through which it is removed as shown in FIGS. 18 and 19. Then the in-mould film 8 is folded before the edge 12 of the transfer plane 9, because there is no auxiliary work plane 2, FIG. 20a, but an outer work plane has been formed in the work piece, FIG. 5 2, replacing the separate auxiliary work plane, FIG. 20a2.

The new invention, a method for manufacturing a work piece, e.g. FIG. 5 and FIG. 10, and the new method for removing the work piece from the manufacturing process, FIGS. 6, 7, 8, FIG. 17, FIG. 18, 19, is advantageous also for the manufacture of moulds, because the ejection pins 11 in FIG. 7 can be disposed outside the product 1 itself, i.e. outside the mould surfaces 14, 15, and hence the quality of the product is also substantially enhanced.

1. A method for manufacturing a work piece, in which the work piece can be removed from the manufacturing step, i.e. a injection-moulding step, transferred between various further processing steps, shifted and treated in these quite automatically without having to touch the desired end product at any stage regardless of the work process, unless the work process, such as e.g. tampon printing etc., so requires, and regardless of the physical dimensions or shapes of the product, and in which two work planes (2, 4) located substantially in the same plane are used, between which the product/products are formed using e.g. the injection-moulding process, characterised in that the desired end product (1a-1d) is always outside the innermost work plane (4) and in that the formed work plane (4) and the desired end product (1a-1d) are always inside the outermost work plane (2) and that the particular work plane (2) has been formed.

2. A method as defined in claim 1, characterised in that all the parts, the product (1), the inner work plane (4), the outer work plane and any clamps assembling these, are made of the same material and simultaneously in the same work process.

3. A method as defined in claim 1, characterised in that areas, such as notches, projections, holes, etc (8, 12, 13, 14) facilitating positioning, transfer, disposition or other work processes have been provided on the outermost work plane (2) and the innermost work plane (4).

4. A method as defined in claim 1, characterised in that the method for manufacturing the work piece is any of the following:
I A plastic injection-moulding process
II A plastic cold-working process
III A plastic hot-working process
IV A metal hot or cold working method
V A metal pressure-casting process
VI A plastic dead-mould casting process
VII Another method for manufacturing metal, plastic, glass, ceramic or any other material
VIII Combining of some other material, object, such as metal parts, covers or an in-mould film with an injection-moulding or dead-mould casting method.

5. A method as defined in claim 1, characterised in that (FIG. 5 2) the outer work plane has been replaced with a separate auxiliary outer work plane (FIGS. 9a and 10 2), which is made of metal and may have similar functions as the stationary (FIG. 5 2) outer work plane.

6. A method as defined in claim 5 for removing the work piece from a mould or a plastic or metal injection-moulding or dead mould casting process, characterised in that (FIGS. 6a, b and c) the work piece is formed in an at least one opening (1 and 2) in a plate in the linear plane (3).

7. A method as defined in claim 6, characterised in that the plate (3) in the linear plane has at least two openings (1 and 2), in which the work piece can be formed alternatingly.

8. A method as defined in claim 7, characterised in that said (FIG. 6) opening in the linear plane plate (3) has edges shaped (as in any of FIGS. 12a, b and c) (as an auxiliary metal ring used in the manufacture of a CD disc) and in that said opening is primarily entirely circular, except for (FIG. 5) projections or recesses (8, 12, 13 and 14).

9. A method as defined in claim 8, characterised in that the opening illustrated (FIG. 6 3) may also have a shape other than circular, oval, triangular, rectangular, square, star-formed or indented.

10. A method as defined in claim 9, characterised in that the linear plane plate illustrated (FIG. 6) has the trajectory of a reciprocating linear movement, and in that the linear plane plate (3 FIG. 6) also moves vertically, in alignment with the opening direction of the mould.

11. A method as defined in claim 10, characterised in that the manufacturing method is a method used in the manufacture of CD-DVD discs.

12. A method as defined in claim 11 for removing a work piece from a manufacturing process, e.g. an injection-moulding process, characterised in being the same as the known method used in the manufacture of CD-DVD discs.

13. A method as defined in claim 12 for removing a work piece as defined above from a manufacturing process, e.g. a injection-moulding process, (FIGS. 18 and 19), characterised in that the transfer surface plate (1) is circular or other in shape and in that it comprises at least two openings (1, 2 and 3) and in that the transfer surface plate (1) is pivoted (14) in the centre and that it may also move reciprocatingly (17) in alignment with the direction of opening the mould (5 and 6).

14. A method as defined in claim 13 for removing a work piece as defined above from e.g. an injection-moulding process (FIGS. 6, 7, 8 and 21), a linear guide, a shaft (FIG. 6abc 4) to which a linear plane plate (3) is attached, (FIGS. 8abc 5 and 6, FIG. 21 3), characterised in that said linear guide (3) is placed between the mould halves (5 and 6), the product (1) being fixed to the linear guide by means of clamps (2) or directly to the linear guide (3), where transfer takes place once the mould halves (5 and 6) have been opened (4), otherwise the operation is the same as above (FIGS. 6 and 8).

15. A method as defined in claim 14, utilising (FIG. 18 3) linear guides, shafts, characterised in that they may be shaped, circular, triangular, oval, flat, etc. and they may comprise protrusions, recesses, etc.

16. A method as defined in claim 15, characterised in that the linear guides are separately fixed to a guide allowing the transfer direction to be changed (FIGS. 6a, b, c).
